(19) United States
(12) Patent Application Publication
(10) Pub. No.: US 2025/0118122 A1
(43) Pub. Date: Apr. 10, 2025

(54) SYSTEM AND METHOD FOR EXECUTING ADDITIONAL ANALYTICS AT AN ACCESS CONTROL POINT

(71) Applicant: MOTOROLA SOLUTIONS, INC., CHICAGO, IL (US)

(72) Inventors: CHEE KIT CHAN, BAYAN LEPAS (MY); LI TEEN TAN, GEORGETOWN (MY); CHIN WUN NG, BAYAN LEPAS (MY)

(21) Appl. No.: 18/481,262

(22) Filed: Oct. 5, 2023

(51) Int. Cl. G07C 9/10; G06V 20/52; G06V 20/62; G06V 40/16

(52) U.S. Cl. CPC G07C 9/10; G06V 20/52; G06V 20/625; G06V 40/172

(57) ABSTRACT

Techniques for executing additional analytics at an access control point are provided. A target at an access control point attempting to traverse the access control point is identified. The target is provided an indication that traversal of the access control point is delayed. Additional analytics resources are directed to the access control point. Additional analytics are run on the target using the additional analytics resources. The target is allowed to traverse the access control point once the additional analytics have completed.

### BACKGROUND

The use of access control systems is widespread. Access control systems can be deployed to ensure that people entering and/or exiting an area are allowed to do so. For example, a car parking lot may utilize an access control system to limit the number of cars entering the lot to the total number of spaces actually available. The parking lot access control system may also prevent a car from leaving the parking lot until they have paid the parking fee.

Access control systems in buildings may perform a similar function. For example, the access control system in a building may require someone who is attempting to enter a building to provide some type of access credential (e.g. RFID badge, fingerprint, iris scan, etc.) before allowing the person to enter the building. In some cases, a building access control system may also require a similar credential when a person is exiting a building, in order to keep track of who is currently in the building.

Access control systems are deployed at access control points. Because these points are places where a user is temporarily delayed while the access control system determines if the person should be granted/denied access, such points may be suitable for the deployment of various types of video analytics. For example, in a parking lot access control system, a video analytics such as an automatic license plate reader (ALPR) may be deployed. In an access control system for people entering a building, a weapons detection video analytic may be used to determine if a person is carrying a weapon.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of a parking lot that may implement the executing additional analytics at an access control point techniques described herein.

FIG. 2 is an example of a building access control system that may implement the executing additional analytics at an access control point techniques described herein.

FIG. 3 is an example of a flow chart for implementing the executing additional analytics at an access control point techniques described herein.

FIG. 4 is an example of a device that may implement the executing additional analytics at an access control point techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In a world of unlimited resources, deploying video analytics capabilities at every access control point would allow for video analytics to be performed on every entity traversing the access control point. Unfortunately, a problem arises in the real world in that resources are not unlimited. Cameras capable of performing video analytics (e.g. ALPR, Weapons Detection, etc.) may be expensive and cost prohibitive to install at every single access point. Even in cases where the video analytics are performed in a cloud computing environment with the cameras at the access control points being relatively inexpensive, there would still be the cost associated with the compute resources required to run the video analytics in the cloud.

An additional problem arises in that performing the video analytics on an entity attempting to traverse an access control point may require additional time. Although video analytics are ever improving, a certain amount of time may be required for those video analytics to run. This problem may be made worse if the video analytics are performed in the cloud, as opposed to on a camera at the access control point, because there will be a delay introduced when the raw video from the camera at the access control point is sent to the cloud for video analytics processing. This additional delay, when applied to every entity traversing the access control point, may cause queues to form at the access control point, thus delaying everyone who wishes to traverse the access control point.

The techniques described herein solve these problems individually and collectively. Initially, it may be determined if additional video analytics are required in the first place. For example, if it was determined that there was something unusual about the entity traversing the access control point, the system may decide that additional video analytics need to be performed. Because the additional video analytics are only performed when something unusual is detected, the use of resources is reduced because the video analytics are not performed for every entity traversing the access control point.

Once it is determined that there is something unusual about the entity traversing the access control point, additional video analytics resources may be directed to the access control point. For example, in the case of a camera equipped with video analytics, the camera may be directed to Pan-Tilt-Zoom (PTZ) to the location of the access control point where the unusual entity has been identified. Because the camera can PTZ to different access control points, costs can be reduced as each access control point need not be equipped with additional video analytics resources, as they can be shared amongst multiple access control points.

In some cases, the additional video analytics resources may include processing resources. For example, an access control point may be equipped with its own camera that does not perform video analytics. When an unusual entity has been identified, cloud processing resources may be assigned to perform additional video analytics. Again, since this is only done once unusual activity has been detected, the additional video analytics are not required for every entity traversing the access control point, thus reducing the amount of cloud resources required to perform video analytics.

It is possible that the time required to direct the additional video analytic resources may require a period of time to setup. For example, a PTZ camera cannot move from one capture position to another instantaneously. The PTZ motion is a physical motion within the camera that requires time. Likewise, if the additional video analytics resources are in a cloud computing environment, there may be a period of time required to establish the connection from the camera at the access control point to the cloud computing resources. In addition to the setup time, the additional video analytics themselves, regardless of if run on the camera or in the cloud, may require a period of time to run. Depending on the sophistication of the additional video analytics, this processing time might not be trivial and may be perceptible by the entity traversing the access control point.

If the entity traversing the access control point notices that a pervious person's traversal of the access control point was quick (e.g. no unusual activity detected, so no additional video analytics performed), they may become suspicious. For example, when exiting a car parking lot, the car in front of the subject car was only held for one second, and the current entity has been held for significantly longer. This may be especially true in the case of people who have already been identified as having unusual activity. To alleviate this suspicion, the entity traversing the access control point me be provided with a message that indicates the system is having some type of error (e.g. network error, etc.) and that processing is taking longer than expected. By providing a misleading message, the entity traversing the access control point is not made aware that their activity has already been determined to be unusual, and due to the unusual nature of the activity, additional video analytics are being performed.

A method for executing additional analytics at an access control point is provided. The method includes identifying a target at an access control point attempting to traverse the access control point. The method also includes providing an indication to the target that traversal of the access control point is delayed. The method also includes directing additional analytics resources to the access control point. The method also includes running additional analytics on the target using the additional analytics resources. The method also includes allowing the target to traverse the access control point once the additional analytics have completed.

In one aspect, the method includes causing a camera to pan-tilt-zoom to capture the target. In one aspect, the method includes initially identifying the target based on an event of interest.

A system for executing additional analytics at an access control point is provided. The system includes a processor and a memory coupled to the processor. The memory contains a set of instructions thereon that cause the processor to identify a target at an access control point attempting to traverse the access control point. The instructions further cause the processor to provide an indication to the target that traversal of the access control point is delayed. The instructions further cause the processor to direct additional analytics resources to the access control point. The instructions further cause the processor to run additional analytics on the target using the additional analytics resources. The instructions further cause the processor to allow the target to traverse the access control point once the additional analytics have completed.

In one aspect of the system, the instructions further cause the processor to cause a camera to pan-tilt-zoom to capture the target. In one aspect of the system, the instructions further cause the processor to initially identify the target based on an event of interest.

A non-transitory processor readable medium containing instructions for executing additional analytics at an access control point is provided. The instructions on the medium, that when executed by a processor, cause the processor to identify a target at an access control point attempting to traverse the access control point. The instructions on the medium also cause the processor to provide an indication to the target that traversal of the access control point is delayed. The instructions on the medium also cause the processor to direct additional analytics resources to the access control point. The instructions on the medium also cause the processor to run additional analytics on the target using the additional analytics resources. The instructions on the medium also cause the processor to allow the target to traverse the access control point once the additional analytics have completed.

In one aspect of the non-transitory computer readable medium, the instructions cause the processor to cause a camera to pan-tilt-zoom to capture the target. In one aspect of the non-transitory computer readable medium, the instructions cause the processor to initially identify the target based on an event of interest.

In one aspect, the target is identified based on an unusual appearance. In one aspect, the target is identified based on unusual behavior. In one aspect, the additional analytics are automatic license plate recognition analytics. In one aspect, the additional analytics are facial recognition analytics. In one aspect, the access control point is an exit barrier of a parking lot. In one aspect, the access control point controls access of targets on foot. In one aspect, the additional analytics are at least one of heat detection, chemical detection, and radiation detection.

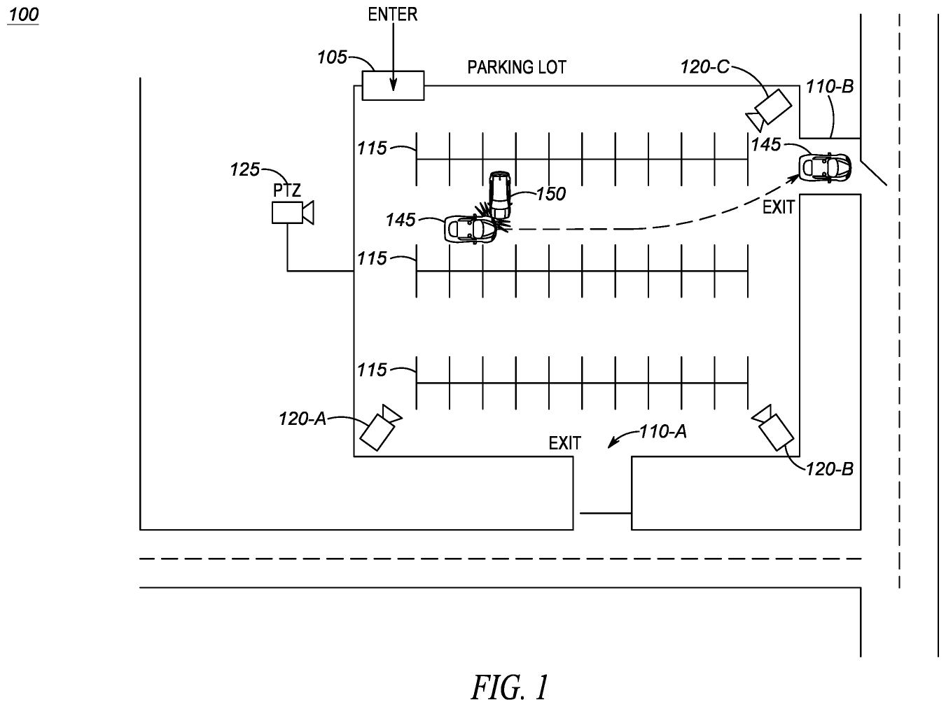

FIG. 1 is an example of a parking lot 100 that may implement the executing additional analytics at an access control point techniques described herein. In the example shown, the parking lot may include an entrance 105, two exits 110-A, B, and a plurality of parking spots 115. The parking lot may also include a plurality of cameras 120-A-C, which can be considered simple cameras as well as a PTZ Video Analytics Camera 125. It should be understood that the simplicity of the parking lot 100 is for ease of description only. In an actual implementation, there may be any number of entrances, exits, simple cameras, and PTZ video Analytics cameras.

The entrance 105 may be protected by some form of access control. For example, there may be a gate that prevents a vehicle from entering the parking lot 100 until authorized. In one example implementation, the gate may include some type of credential reader (e.g. RFID Badge, QR code reader, etc.) which allows a user to present a credential that indicates they are authorized to enter the parking lot. Upon authorization, the access control system may allow the vehicle to enter (e.g. raise the gate, etc.). In other implementations, the access control system may instruct the vehicle owner to obtain a ticket, which may later be used to pay for any parking fees and utilized when it is time to exit the parking lot. Although the access control system is described as being a gate, it should be understood that the techniques described herein may be utilized with any other mechanism (e.g. retractable bollards, retractable spikes, etc.). What should be understood is that the access control system 105 controls vehicles entering the parking lot.

The exits 110-A, B may also be protected with access control systems similar to those described with respect to entrance 105. The exit access control systems may prevent a vehicle from leaving the parking lot until authorized. For example, the exit access control system may prevent a vehicle from leaving the parking lot until it is determined that the vehicle owner has properly paid for parking. In once example implementation, the exit access control system may include a payment card acceptance device that allows the vehicle owner to pay for parking at the access control point. In another implementation, the vehicle owner may pay for parking at a kiosk, receiving a ticket indicating the parking fee has been paid. The vehicle owner may present this ticket to the exit access control system to exit the parking lot.

The access control systems at the exits 110 may also include a display that allows information to be sent to the driver of the vehicle exiting. The particular form of the display is unimportant. It may be a simple liquid crystal display, a flat panel screen, a touch screen, or any other suitable display. What should be understood is that the access control system is able to convey messages to the driver of the exiting vehicle. The use of these messages will be described in further detail below.

Parking lot 100 may also include simple cameras 120-A-C. The simple cameras may be cameras with limited processing power, and as such are only capable of performing limited video analytics. In particular, the simple cameras may be used to detect unusual events. For example, the simple cameras may detect a vehicle hitting a fixed object or another vehicle within the parking lot 100. The simple cameras may be used to detect damage on a vehicle (e.g. broken headlight, dragging bumper, etc.). The simple cameras may be used to detect unusual motion (e.g. driving wrong way down one way aisle, driving across parking spaces, etc.). What should be understood is that the simple cameras may be used to detect unusual events within the parking lot.

The simple cameras 120-A-C may perform analytics to detect unusual events on the camera itself. In other implementations, the simple cameras may be connected to the cloud (not shown) and the unusual event detection is done in the cloud. The techniques described herein are not dependent on any particular implementation of cameras to detect unusual events. Although referred to a simple cameras, this is not intended to imply that that the cameras lack sophisticated processing capabilities. Instead, it is intended to imply that the purpose of the simple camera is to detect unusual events, as opposed to processing complex video analytics, which will be described in further detail below.

In some implementations, when one of the simple cameras 120 detects an unusual event, it may tag the vehicle associated with the unusual event with an identifier. For example, the identifier may be based on the make, model, color, damage, etc. of the vehicle. The identifier may then be stored in a database indicating that this vehicle has been associated with an unusual event. As will be described in further detail below, when the vehicle attempts to exit the parking lot, a simple camera whose field of view covers the exit 110 may determine if the exiting vehicle is associated with an identifier (e.g. was previously associated with an unusual event, etc.). If so, additional analytics may be performed, as will be described in further detail below.

Parking lot 100 may include PTZ Video Analytics Camera 125, which can interchangeably be referred to as an analytics camera. The analytics camera may be configured to perform detailed video analytics that are more sophisticated that those performed by the simple cameras 120. For example, the video analytics may include automatic license plate recognition (ALPR) video analytics to determine the license plate of a vehicle. The video analytics could also include facial recognition analytics to identify the driver of the vehicle. The techniques described herein are suitable for use with any video analytics. What should be understood is that the video analytics performed by the analytics cameras may be expensive to perform for several reasons.

For example, the video analytics may be expensive in terms of processing power (e.g. facial recognition is computationally expensive, etc.). If the processing is done on the camera itself, this means that the camera itself is likely to be expensive, and may be cost prohibitive to install multiple such cameras in the parking lot to cover every exit. If the processing is done in a cloud computing environment, the cost to perform video analytics on every vehicle exiting the parking lot 100 may be prohibitive. In some cases, the video analytics may be expensive in terms of time. For example, a sophisticated facial recognition algorithm may take several seconds or minutes to run (e.g. needs to wait until the person's face is properly oriented, etc.).

In the parking lot 100, the analytics camera 125 may be mounted in such a way that the field of view of the camera can be PTZ to each of the exits 110. As mentioned above, the PTZ operation, although quick, is not instantaneous. There is a non-zero amount of time needed to move the field of view of the analytics camera from one position to another. In the example, shown, the analytics camera is mounted on a pole in a position that allows the field of view of the analytics camera to be moved between exit 110-A and exit 110-B.

Operation of the parking lot will now be described by way of an example. A vehicle 145 may have entered the parking lot 100 via the entry 105. The vehicle 145 may strike (accidently or maliciously) a parked vehicle 150. The simple camera 120-C may detect this collision and consider it an unusual event. The simple camera may make note of vehicle characteristics that can be used to later identify the vehicle 145. Examples of such characteristics can include vehicle make, model, color, damage, etc. What should be understood is that the characteristics used are such that they can be used to re-identify the vehicle at a later time (e.g. when the vehicle is attempting to leave the parking lot, etc.).

Although the example presented described a collision as the unusual event, it should be understood this was for ease of description, and not by way of limitation. An unusual event could be any number of things. For example, driving with excessive speed, aggressive driving, driving the wrong way on a one way road, vehicle damage, etc. The techniques described herein are suitable for use with any unusual event. What should be understood is that the unusual event makes the vehicle 145 a target.

The vehicle 145 may then, at some point, decide to exit the parking lot 100. For example, the vehicle may attempt to exit via exit 110-B. One of the simple cameras, for example simple camera 120-A, may detect that the vehicle 145 is a target because it was associated with an unusual event (e.g. the collision with vehicle 150, etc.). The access control system protecting exit 110-B may be notified that additional analytics requiring additional time will be performed on the vehicle attempting to exits.

The access control system at exit 110-B may use its display to provide a message to the driver of vehicle 145 indicating that traversing the exit will be delayed. In some implementations, in order to not raise suspicions of the driver, a false reason may be provided. For example, the message may be, “The network is operating slowly, we thank you for your patience” or any such similar message may be provided. What should be understood is that the message may be provided to alleviate any concerns of the driver as to why the exit process is taking longer than to be expected. By providing a false reason, the drive is not aware the delay is due to additional video analytics. In some implementations, the drive may simply be required to wait, without any reason, true or otherwise, being provided.

Once it is determined that the target vehicle 145 is associated with an unusual event and should have additional video analytics performed, the PTZ video analytics camera 125 may be directed to PTZ its field of view to the exit 110-B to perform additional video analytics. As mentioned above, those video analytics could include ALPR, facial recognition, etc. In addition, those video analytics could include obtaining close up pictures (e.g. of license plate, damaged areas of vehicle, etc.), a larger field of view capturing the entire vehicle, a higher resolution image, etc.

It should be understood that the techniques described herein would also be suitable for use when there is an analytics camera 125 directed at each of the exits 110 (e.g. no need to PTZ from one exit to the other). What should be understood is that traversal of the access point by the target is delayed until the additional video analytics are complete, regardless of which camera performs those analytics.

The results of the additional video analytics may then be useful at a later time to identify a vehicle involved in an unusual event. For example, at a later time the owner of vehicle 150 may come to the owner of the parking lot 100 and complain that there is damage to their vehicle. The particular type of damage may be associated with the unusual collision event. In a normal exit, license plate, facial recognition, or any other additional analytics may not be performed. However, in this case, because there was an unusual event, the additional analytics that may be used to identify vehicle 145 were performed. As such, there is more information available about vehicle 145 to be used for other activities (e.g. filing police report, etc.).

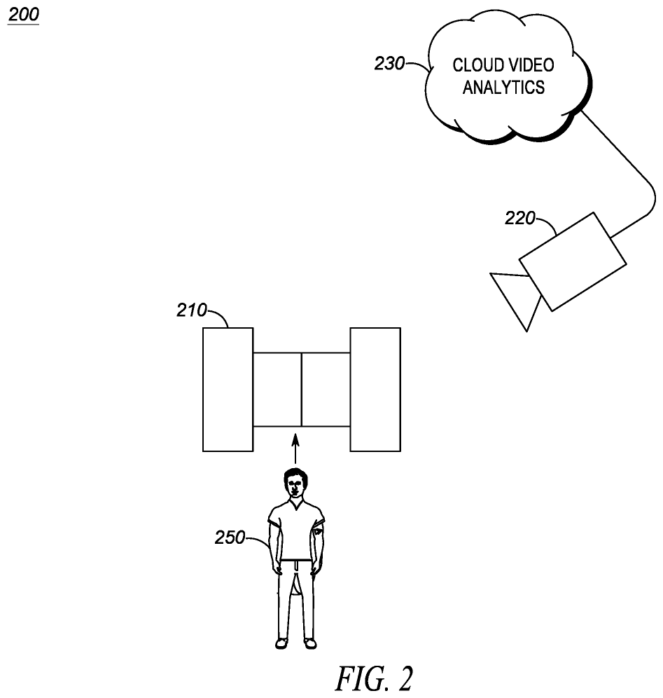

FIG. 2 is an example of a building access control system 200 that may implement the executing additional analytics at an access control point techniques described herein. The building access control system 200 may include an access control point 210, a video analytics camera 220, and a cloud video analytics system 230.

The access control point 210 may take many forms and the techniques described herein are not dependent on any particular form. What should be understood is that there is a restricted area, such as access to a building, a room within the building, a floor of a building, or any such area where it is desired to control access. The access control system is designed such that access to the restricted area can only be achieved through an access control point.

Some simple examples of access control points 210 can include doors with electronic locks, gates, man traps, etc. A person wishing to enter the restricted area must provide proper credentials to the access control point before being allowed access. Credentials may include an electronic badge, password, personal identification number, biometric credentials (e.g. fingerprints, iris scan, palm scan, DNA, etc.). The particular form of the credential is unimportant with respect to the techniques described herein.

The building access control system 200 may also include a video analytics camera 220. The video analytics camera 220 may be a camera capable of performing additional advanced video analytics (e.g. facial recognition, weapons detection, etc.). The video analytics camera 220 may share many of the same characteristics of the PTZ Video Analytics Camera 125 described above. For example, the analytics camera 220 may include the capability to perform additional analytics on the camera itself or may be coupled to a cloud computing system to perform additional video analytics.

The building access control system 200 may be coupled to a cloud video analytics system 230. The cloud video analytics system may provide processing resources outside of the camera to perform additional video analytics. Offloading such processing to a cloud computing environment may allow the video analytics camera 220 to be more cost effective, as it does not require as much processing power.

In operation, a person 250 may wish to enter the building protected by the building access control system 200. As the person is approaching the access control point 210, the video analytics camera 220 may perform basic video analytics to determine if the person 250 is exhibiting unusual behavior. For example, making repeated approaches and then backing away from the access control point. Another example may include signs of nervousness, such as shaking or excessive sweating. Another example can include a person who is not dressed appropriately for the circumstances (e.g. wearing winter coat during the summer, etc.). In other words, the video analytics camera may detect unusual events, just as simple cameras 120 detect unusual events.

In some implementations, the video analytics to detect unusual events are run directly on the video analytics camera 220. In other implementations, the video analytics to detect unusual events are run in the cloud video analytics system 230. Regardless of where the processing to detect unusual events occur, the video analytics camera detects unusual events.

Upon detection of an unusual event the video analytics camera 220, additional video analytics resources may be provided to run additional video analytics on a person who has been determined to be exhibiting unusual behavior. For example, facial recognition or weapons detection video analytics may not normally be performed on every person. This may be because those types of analytics are processing intensive and if the processing is done in the cloud video analytics system, it could result in excessive costs.

Just as above with respect to the access control system protecting the exits 110, the access control point 210 may be equipped with a display to communicate with the person 250. If it is determined that the person has engaged in unusual behavior and that additional video analytics should be executed, the display may be used to communicate with the person as to why there is a delay. In some cases, a false reason (e.g., network problems causing the delay, etc.) will be provided in order to not raise the suspicions of the person with the unusual behavior.

The results of the additional video analytics may then be used for later investigation. For example, if facial recognition is performed because a person is exhibiting unusual behavior, and then at a later time it is determined that an incident of some type (e.g. shooting, theft, etc.) has occurred, the facial recognition might be useful in identifying the perpetrator. As another, more immediate example, if the additional video analytics is a weapons detection analytic, and it is determined the person is carrying a weapon in a location where it is not allowed, security personnel could be dispatched immediately to address the situation.

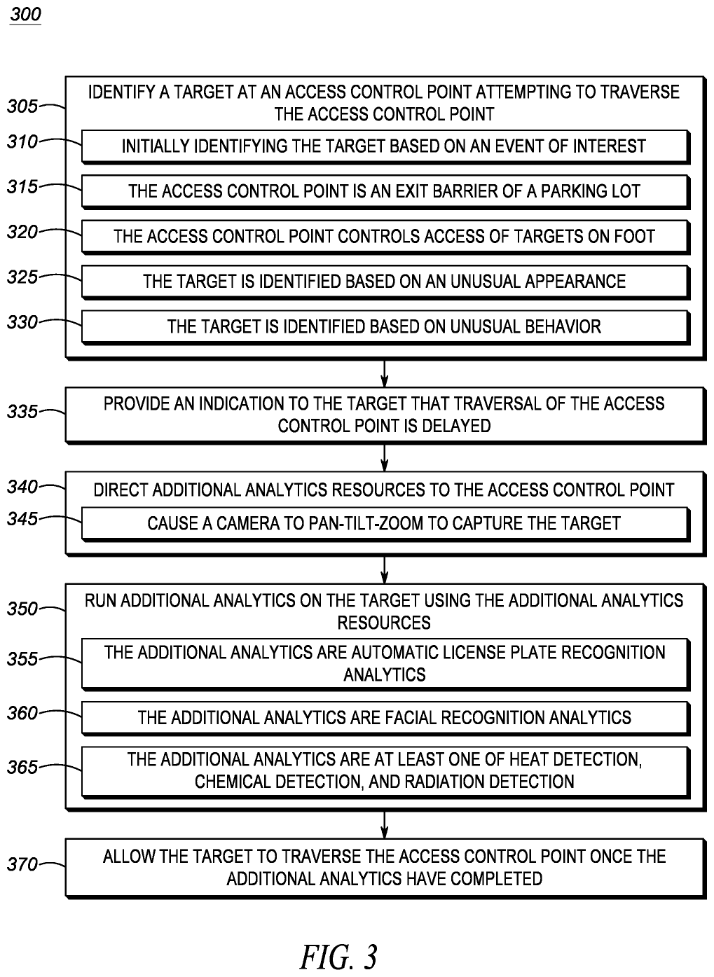

FIG. 3 is an example of a flow chart 300 for implementing the executing additional analytics at an access control point techniques described herein. In block 305, a target at an access control point attempting to traverse the access control point is identified. The reason why the target is identified is described in further detail below. In block 305 it is simply determined that there is a target that is attempting to pass through an access control point to access another area. In the examples presented, the access control point could be the barrier at the exit of the parking lot or the access control point protecting ingress into a building or other secure area.

In block 310, the target is initially identified based on an event of interest. The event of interest may be an unusual behavior or appearance described below. What should be understood is that there is some event associated with the target that makes it desirable to run additional analytics. This is opposed to running additional analytics on all entities attempting to traverse the access control point, as this is an unnecessary use of resources, potentially resulting in additional expense.

In block 315, it is shown that one example of an access control point is an exit barrier of a parking lot. For example, the exit 110-A of the parking lot 100 described with respect to FIG. 1. In block 320 it is shown that one example of an access control point controls access of targets on foot. For example, building access control system 200 includes access control point 210 which controls access to the restricted areas of the building by people on foot. It should be understood that blocks 315 and 320 are simply examples of access control points that may utilize the techniques described herein. An access control point where entry/exit to a controlled area may be delayed while additional analytics are performed is suitable for use with the techniques described herein.

In block 325, the target is identified based on an unusual appearance. As described above, the unusual event, which can also be referred to as an event of interest, maybe an unusual appearance of the target (e.g. wearing a winter coat in the summer, etc.). In block 330, the event of interest may be the target is identified based on unusual behavior. For example, a person repeatedly approaching and then moving away from a access control point of a vehicle going the wrong way down a one way street. It should be understood that these are simply examples of type of events of interest. The techniques described may be used with any other mechanism for detecting events of interest (e.g. unusual events, etc.).

In block 335, an indication to the target that traversal of the access control point is delayed is provided. As explained above, when additional analytics are performed on the target, the time to perform those analytics may be longer than if those analytics are not performed. By providing the target an indication that there will be a delay, the target may not become irritated if it appears that the access control point traversal process is taking too long. In some cases, the indication may be specifically misleading (e.g. delay is due to network problems, etc.) to avoid tipping the target of that there is some additional processing being done on this particular target.

In block 340, additional analytics resources are directed to the access control point. For example, a camera that may perform video analytics in a cloud environment may be directed to acquire cloud resources (e.g. processing power, etc.) to run additional analytics. In some cases the additional analytics resources may be located on a camera whose field of view covers the access control point. In other cases, the additional resources may be sensors used to detect non-visual data.

In one example, shown in block 345, the additional resources are directed to the access control point by causing a camera to pan-tilt-zoom to capture the target. As explained above, the analytics resources may be expensive to provide. By allowing the analytics resources to be shared amongst multiple access control points, the expense can be reduced. A camera capable of PTZ could provide additional analytics resources to multiple access control points.

In block 350, additional analytics may be run on the target using the additional analytics resources. As described above, it may be cost prohibitive or too time consuming to run additional analytics on every entity traversing an access control point. By limiting the running of these additional analytics to only select targets (e.g. those associated with unusual events, etc.) the cost that comes with running the additional analytics can be avoided.

In block 355, one example of an additional analytics are automatic license plate recognition analytics. Performing automatic license plate recognition may require the use of significant processing resources, either on a camera or in the cloud. In block 360, another example of additional analytics may be facial recognition analytics. By only performing facial recognition analytics on selected targets, the amount of processing resources used may be reduced. Furthermore, only performing facial recognition on targets associated with unusual events may alleviate public concern over loss of privacy.

The previous examples of analytics have been directed to visual based analytics. However the techniques described herein are not so limited. In block 365, the additional analytics are at least one of heat detection, chemical detection, and radiation detection. For example, in the case of a vehicle, heat detection may be used to identify operational issues with the vehicle (e.g. faulty brakes, improper exhaust system, etc.). Chemical and radiation detection analytics may be used to determine if a person is bringing dangerous substances into a restricted area. Although only several examples are provided, it should be understood that the additional analytics that may be run on the target are not limited to visual based analytics.

In block 370, the target is allowed to traverse the access control point once the additional analytics have completed. One the additional analytics are completed, there is no longer a need to delay the targets traversal through the access control point. As such, depending on the type of access control system, a gate may be raised or opened, a door unlocked, or whatever access control system specific technique may be used to allow the target to pass through the access control system.

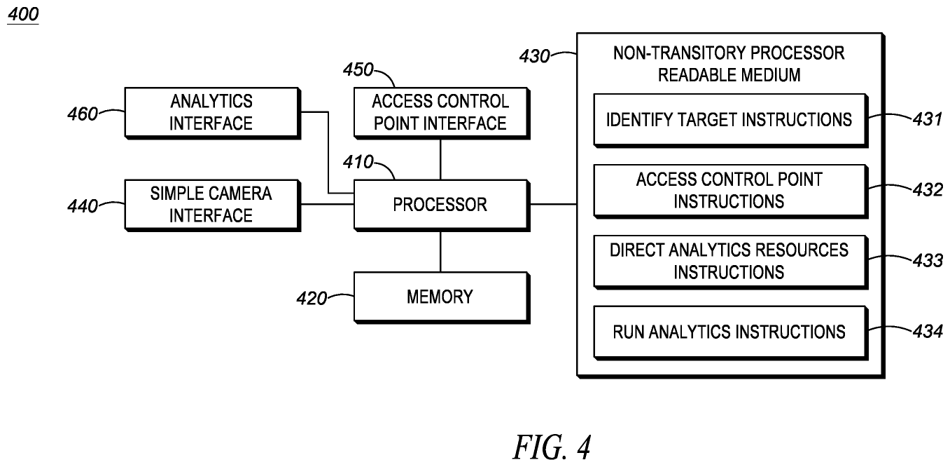

FIG. 4 is an example of a device that may implement the executing additional analytics at an access control point techniques described herein. It should be understood that FIG. 4 represents one example implementation of a computing device that utilizes the techniques described herein. Although only a single processor is shown, it would be readily understood that a person of skill in the art would recognize that distributed implementations are also possible. For example, the various pieces of functionality described above (e.g. video analytics, audio analytics, etc.) could be implemented on multiple devices that are communicatively coupled. FIG. 4 is not intended to imply that all the functionality described above must be implemented on a single device.

Device 400 may include processor 410, memory 420, non-transitory processor readable medium 430, simple camera interface 440, access control point interface 450, and analytics interface 460.

Processor 410 may be coupled to memory 420. Memory 420 may store a set of instructions that when executed by processor 410 cause processor 410 to implement the techniques described herein. Processor 410 may cause memory 420 to load a set of processor executable instructions from non-transitory processor readable medium 430. Non-transitory processor readable medium 430 may contain a set of instructions thereon that when executed by processor 410 cause the processor to implement the various techniques described herein.

For example, medium 430 may include identify target instructions 431. The identify target instructions 431 may cause the processor to identify unusual events. For example, the identify target instructions 431 may cause the processor to utilize the simple camera interface 440 to detect unusual events. The identify target instructions 431 are described throughout the specification generally, including places such as the description of blocks 305-330.

The medium 430 may include access control point instructions 432. The access control point instructions 432 may cause the processor to control the access control point via the access control point interface 450. The access control point instructions 432 may cause the processor to delay the targets traversal through the access control point and may provide a reason for the delay. The access control point instructions 432 are described throughout the specification generally, including places such as the description of blocks 335 and 370.

The medium 430 may include direct analytics resources instructions 433. The direct analytics resources instructions 433 may cause the processor to use the analytics interface 460 to direct additional analytics to the target. For example, this may include obtaining additional cloud computing resources to perform analytics or causing a PTZ camera to change its field of view to cover the target. The direct analytics resources instructions 433 are described throughout the specification generally, including places such as the description of blocks 340 and 345.

The medium 430 may include run analytics instructions 434. The run analytics instructions 434 may cause the processor to, using the analytics interface 460, to run the additional analytics using the previously obtained analytics resources. The run analytics instructions 434 are described throughout the specification generally, including places such as the description of blocks 350-365.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot perform additional automated video analytics on an identified target, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for executing additional analytics at an access control point comprising:
identifying a target at an access control point attempting to traverse the access control point;
providing an indication to the target that traversal of the access control point is delayed;
directing additional analytics resources to the access control point;
running additional analytics on the target using the additional analytics resources; and
allowing the target to traverse the access control point once the additional analytics have completed.

2. The method of claim 1 wherein the target is identified based on an unusual appearance.

3. The method of claim 1 wherein the target is identified based on unusual behavior.

4. The method of claim 1 wherein the additional analytics are automatic license plate recognition analytics.

5. The method of claim 1 wherein the additional analytics are facial recognition analytics.

6. The method of claim 1 wherein the access control point is an exit barrier of a parking lot.

7. The method of claim 1 wherein the access control point controls access of targets on foot.

8. The method of claim 1 further comprising:
causing a camera to pan-tilt-zoom to capture the target.

9. The method of claim 1 wherein the additional analytics are at least one of heat detection, chemical detection, and radiation detection.

10. The method of claim 1 further comprising:
initially identifying the target based on an event of interest.

11. A system for executing additional analytics at an access control point comprising:
a processor; and
a memory coupled to the processor containing a set of instructions thereon that when executed by the processor cause the processor to:
identify a target at an access control point attempting to traverse the access control point;
provide an indication to the target that traversal of the access control point is delayed;
direct additional analytics resources to the access control point;
run additional analytics on the target using the additional analytics resources; and
allow the target to traverse the access control point once the additional analytics have completed.

12. The system of claim 11 wherein the target is identified based on an unusual appearance.

13. The system of claim 11 wherein the target is identified based on unusual behavior.

14. The system of claim 11 further comprising instructions that cause the processor to:
cause a camera to pan-tilt-zoom to capture the target.

15. The system of claim 11 further comprising instructions that cause the processor to:
initially identify the target based on an event of interest.

16. A non-transitory processor readable medium containing instructions for executing additional analytics at an access control point thereon, that when executed by a processor cause the processor to:
identify a target at an access control point attempting to traverse the access control point;
provide an indication to the target that traversal of the access control point is delayed;
direct additional analytics resources to the access control point;
run additional analytics on the target using the additional analytics resources; and
allow the target to traverse the access control point once the additional analytics have completed.

17. The non-transitory processor readable medium of claim 16 wherein the target is identified based on an unusual appearance.

18. The non-transitory processor readable medium of claim 16 wherein the target is identified based on unusual behavior.

19. The non-transitory processor readable medium of claim 16 further comprising instructions that cause the processor to:
cause a camera to pan-tilt-zoom to capture the target.

20. The non-transitory processor readable medium of claim 16 further comprising instructions that cause the processor to:
initially identify the target based on an event of interest.
